(19) United States
(12) Patent Application Publication
(10) Pub. No.: US 2024/0356366 A1
(43) Pub. Date: Oct. 24, 2024

(54) SOLAR POWER COMBINER

(71) Applicant: Goal Zero LLC, Bluffdale, UT (US)

(72) Inventors: Sterling Robison, Cottonwood Heights, UT (US); Benjamin Peter Lindow, Lindon, UT (US)

(21) Appl. No.: 18/639,658

(22) Filed: Apr. 18, 2024

Related U.S. Application Data
(60) Provisional application No. 63/497,378, filed on Apr. 20, 2023.

(51) Int. Cl. H02J 7/35; H02S 40/36; H02S 40/38; H02S 50/00

(52) U.S. Cl. CPC H02J 7/35; H02S 40/36; H02S 40/38; H02S 50/00; H02J 2207/20

(57) ABSTRACT

A charging system may include multiple solar panels. Each of the solar panels may be configured to generate DC power and the solar panels may be divided into multiple solar panel groups. The system may also include a power combiner device electrically coupled to the solar panel groups and configured to selectively combine the DC power from the solar panel groups connected thereto in parallel based on electrical characteristics of the DC power from the solar panel groups.

### CROSS REFERENCE TO RELATED APPLICATIONS

This patent application claim priority to U.S. Provisional Patent Application Ser. No. 63/497,378, filed Apr. 20, 2023, which is incorporated herein by reference.

### FIELD

The embodiments discussed herein are related to a solar power combiner.

### BACKGROUND

Solar panels may be used to generate electricity. For example, solar panels may be installed on structures and may be tied into an electrical grid that is coupled to the structure. As a result, electrical power generated by the solar panels may be used to power the structure and/or to power the electrical grid.

The subject matter claimed herein is not limited to embodiments that solve any disadvantages or that operate only in environments such as those described above. Rather, this background is only provided to illustrate one example technology area where some embodiments described herein may be practiced.

### SUMMARY

A charging system may include multiple solar panels. Each of the solar panels may be configured to generate DC power and the solar panels may be divided into multiple solar panel groups. The system may also include a power combiner device electrically coupled to the solar panel groups and configured to selectively combine the DC power from the solar panel groups connected thereto in parallel based on electrical characteristics of the DC power from the solar panel groups.

### BRIEF DESCRIPTION OF THE DRAWINGS

Example embodiments will be described and explained with additional specificity and detail through the use of the accompanying drawings in which:

FIG. 1 illustrates an environment that includes a system to combine power;

FIG. 2 illustrates a parallel combiner device;

FIG. 3 illustrates a flowchart of an example method to combine power;

FIG. 4 illustrates a flowchart of another example method to combine power; and

FIG. 5 illustrates an example system that may be used for power combination.

### DETAILED DESCRIPTION

Solar panels may be used to generate DC power. For example, solar panels may be installed on buildings, such as homes or office spaces, to generate DC power. In some instances, the DC power may be converted to AC power and provided to an electrical grid that provides AC power to the building. Alternately or additionally, the DC power may be stored in a storage device, such as a battery, near or in the building.

In some instances, the storage device may be capable of accepting a larger DC power input than the DC power output by one or more solar panels. For example, a storage device may accept up to 2800 W of DC power. A single solar panel may generate 200 W. As such, the power from fourteen solar panels may be combined to input to the storage device. In these and other embodiments, the voltage accepted by the storage device may be larger than the voltage output by a solar panel. However, the voltage accepted by the storage device may not be fourteen times larger than the voltage output by a solar panel. As such, the DC power output by the solar panels may be combined serially and in parallel to achieve a power level that may be better suited for providing to the storage device.

Some embodiments described in this disclosure may be directed to serial and parallel combiner devices configured to combine DC power from solar panels and/or other devices to provide to a storage device or another device, such as a DC to AC converter. In these and other embodiments, the parallel combiner device may be configured to monitor and enable/disable the DC power inputs provided to the parallel combiner device to help to reduce issues with power feedback due to differences in voltage levels of the DC power provided to the parallel combiner device.

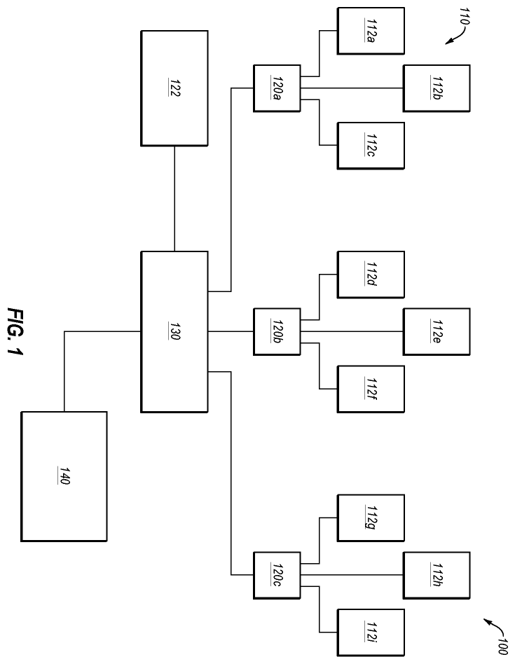

FIG. 1 illustrates an environment 100 that includes a system to combine power, in accordance with some embodiments of the present disclosure. The environment 100 may include a solar panel array 110, a first serial combiner device 120a, a second serial combiner device 120b, and a third serial combiner device 120c, referred to collectively as the serial combiner devices 120, a power source 122, a parallel combiner device 130, and a battery system 140.

In some embodiments, the solar panel array 110 may include any number and type of solar panels. FIG. 1 illustrates a first solar panel group 112a, a second solar panel group 112b, a third solar panel group 112c, a fourth solar panel group 112d, a fifth solar panel group 112e, a sixth solar panel group 112f, a seventh solar panel group 112g, an eighth solar panel group 112h, and a ninth solar panel group 112i, referred to collectively as the solar panel groups 112 in the solar panel array 110. However, the solar panel array 110 may include any number of solar panels and any type of configuration.

In some embodiments, the solar panels in the solar panel groups 112 may be any type of solar panels, such as monocrystalline, polycrystalline, passivated emitter and rear contact panels, or thin-film panels. Each of the solar panels in the solar panel groups 112 may be configured to generate direct current (DC) power, e.g., a DC voltage and a DC current, in response to light. The current and the voltage generated by each of the solar panels may be similar or different. Each of the solar panels may include one or more photovoltaic cells that are coupled together physically and electronically within a housing and the DC power may be output from the housing.

In some embodiments, each of the solar panel groups 112 may include one or more solar panels. For example, each of the solar panel groups 112 may include one, two, three, four, or more solar panels. In these and other embodiments, the solar panels in one of the solar panel groups 112 may be grouped together based on the solar panels providing the DC power generated by the solar panels together to one of the serial combiner devices 120. For example, the solar panels in the solar panel groups 112 may be connected together with devices internal or externally and provide the combined DC power of the solar panels in one of the solar panel groups 112 to one of the serial combiner devices 120. In these and other embodiments, as described a solar panel group 112 may include a single solar panel. In these and other embodiments, the single solar panel may provide the DC power generated by the single solar panel to one of the serial combiner devices 120.

In some embodiments, each of the solar panel groups 112 may be coupled to one of the serial combiner devices 120. In these and other embodiments, multiple of the solar panel groups 112 may be coupled to one of the serial combiner devices 120. For example, as illustrated, three of the solar panel groups 112 may be coupled to one of the serial combiner devices 120. For example, the first solar panel group 112a, the second solar panel group 112b, and the third solar panel group 112c may be coupled to the first serial combiner device 120a. The fourth solar panel group 112d, the fifth solar panel group 112e, and the sixth solar panel group 112f may be coupled to the second serial combiner device 120b. The seventh solar panel group 112g, the eighth solar panel group 112h, and the ninth solar panel group 112i may be coupled to the third serial combiner device 120c.

In some embodiments, the serial combiner devices 120 may each be configured to serially combine the DC power from the solar panel groups 112 coupled thereto. For example, the first serial combiner device 120a may serially combine the DC power from the first solar panel group 112a, the DC power from the second solar panel group 112b, and the DC power from the third solar panel group 112c. In these and other embodiments, serially combining the DC power results in the voltage of the DC power output by the serial combiner device 120 being a combination of the voltages of the DC power obtained by the serial combiner device 120 and the current of the DC power output by the serial combiner device 120 being the same or approximately the same as the current of the DC power obtained by the serial combiner device 120. For example, when the DC power output by the first solar panel group 112a is 12V and 3 A, the DC power output by the second solar panel group 112b is 12V and 3 A, and the DC power output by the third solar panel group 112c is 12V and 3 A, the first serial combiner device 120a may output DC power of 36V and 3 A.

In some embodiments, each of the serial combiner devices 120 may include elements such as a busbar coupled to each of the solar panel groups 112 where the busbars are electrically coupled together. Alternately or additionally, each of the serial combiner devices 120 may include one or more of: diodes to prevent reverse current from flowing from one solar panel group to another, circuit breakers or fuses for overcurrent protection, surge protection devices for voltage surges, disconnect switches, among other elements.

As illustrated, each of the serial combiner devices 120 may be coupled to three solar panel groups 112. However, the serial combiner devices 120 may be coupled to any number of solar panel groups 112. For example, each of the serial combiner devices 120 may be coupled to 2, 3, 4, 5, 6, 7, 8, or more solar panel groups 112. In these and other embodiments, each of the serial combiner devices 120 may be coupled to the same number of solar panel groups 112 or a different number of solar panel groups 112. For example, the first serial combiner device 120a may be coupled to three solar panel groups 112 and the second serial combiner device 120b may be coupled to four solar panel groups 112.

In some embodiments, the number of the solar panel groups 112 coupled to each of the serial combiner devices 120 may be configured so that each of the serial combiner devices 120 outputs a DC power with an approximately equal voltage given normal operating conditions or operating conditions selected by a user. For example, when initially configured the serial combiner devices 120 may be coupled to a particular number of the solar panel groups 112 such that each of the serial combiner devices 120 outputs an approximately equal voltage. Alternately or additionally, the solar panel groups 112 may be configured to provide an approximately equal power, current and/or voltage to each of the serial combiner devices 120. Thus, the number of solar panel groups 112 and a number of solar panels in each of the solar panel groups 112 may be configured such that each of the serial combiner devices 120 provides an approximately equal power, current, and/or voltage given normal operating conditions or operating conditions selected by a user.

In some embodiments, the serial combiner devices 120 may provide the DC power to the parallel combiner device 130. In these and other embodiments, the serial combiner devices 120 may be passive device that are configured to be constantly provide the power from the solar panel groups 112 to the parallel combiner device 130. Alternately or additionally, the serial combiner devices 120 may be active devices that may switch between providing the DC power between the solar panel groups 112 and parallel combiner device 130 and not providing the DC power to the parallel combiner device 130 from the solar panel groups 112. For example, the serial combiner devices 120 may include a switch that isolates the solar panel groups 112 from the parallel combiner device 130 or electrically couples the solar panel groups 112 to the parallel combiner device 130.

In some embodiments, the parallel combiner device 130 may be electrically coupled to the outputs of the serial combiner devices 120. In these and other embodiments, the parallel combiner device 130 may be configured to parallelly combine the DC power from the serial combiner devices 120 coupled thereto. For example, the parallel combiner device 130 may parallelly combine the DC power from the first serial combiner device 120a, the second serial combiner device 120b, and the third serial combiner device 120c. In these and other embodiments, parallelly combining the DC power results in the current of the DC power output by the parallel combiner device 130 being a combination of the currents of the DC power obtained by the parallel combiner device 130 and the voltage of the DC power output by the parallel combiner device 130 being the same or approximately the same as the voltage of the DC power obtained by the parallel combiner device 130. For example, when the DC power output by the first serial combiner device 120a is 36V and 3 A, the DC power output by the second serial combiner device 120b is 36V and 3 A, and the DC power output by the third serial combiner device 120c is 36V and 3 A, the parallel combiner device 130 may output DC power of 36V and 9 A.

In some embodiments, the parallel combiner device 130 may be configured to be able to enable and disable each of the DC power inputs from the serial combiner devices 120. For example, the parallel combiner device 130 may be configured to enable the DC power input from the first serial combiner device 120a so that the DC power from the first serial combiner device 120a is part of the DC power output by the parallel combiner device 130. Alternately or additionally, the parallel combiner device 130 may be configured to disable the DC power input from the first serial combiner device 120a so that the DC power from the first serial combiner device 120a is not part of the DC power output by the parallel combiner device 130.

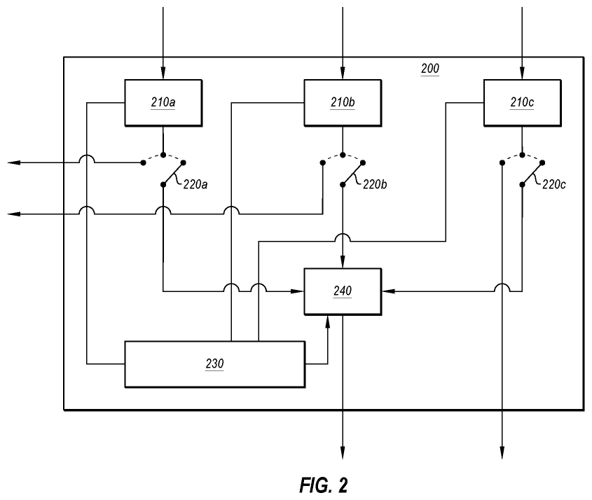

In some embodiments, the parallel combiner device 130 may be configured to enable and/or disable the DC power from each of the serial combiner devices 120 based on the voltage, current, and/or power levels of the DC power obtained from the serial combiner devices 120. Alternately or additionally, the parallel combiner device 130 may be configured to enable and/or disable the DC power from each of the serial combiner devices 120 based on commands from a control system, such as the control system described with respect to FIG. 2. In some embodiments, the voltage, current, and/or power levels of the DC power may be referred to as the electrical characteristic of the DC power. For example, in some instances, the DC power output by each of the serial combiner devices 120 may be different. The differences in the DC power output may result from shading of one or more of the solar panel groups 112, damage, aging, and/or malfunction of one or more of the solar panel groups 112, and a configuration of the solar panel groups 112, among other things.

For example, if the first solar panel group 112a and the second solar panel group 112b are shaded and the other solar panel groups 112 are not shaded, the electrical characteristic, i.e., one or more of voltage, current, and power, generated by the first serial combiner device 120a may be less than the electrical characteristic, i.e., one or more of voltage, current, and/or power, generated by the other serial combiner devices 120. As another example, the solar panels in the fourth solar panel group 112d may be malfunctioning or damaged, the voltage, current, and/or power generated by the second serial combiner device 120b may be less than the voltage, current, and/or power generated by the other serial combiner devices 120. As another example, during installation, the third serial combiner device 120c may have fewer solar panels in the solar panel groups 112 associated with the third serial combiner device 120c than solar panels associated with the other serial combiner devices 120. As a result, the voltage, current, and/or power of the third serial combiner device 120c may be less or more than the voltage, current, and/or power of the other serial combiner devices 120.

In some embodiments, when a voltage, current, and/or power difference greater than a threshold exist between the voltages, currents, and/or power output by the serial combiner devices 120, currents may flow between the serial combiner devices 120 based on the difference. As a result, current may flow back to one or more of the solar panel groups 112. The current flowing back may damage the solar panel groups 112. In these and other embodiments, the parallel combiner device 130 may be configured to detect a voltage, current, and/or power level of the DC power obtained from each of the serial combiner devices 120. For example, in response to the detected voltage levels, the serial combiner devices 120 may enable and/or disable the DC power from each of the serial combiner devices 120 to help to prevent damage to the solar panel groups 112 based on current flowing back to the solar panel groups 112 as a result of differences in voltages of the DC power provided by the serial combiner devices 120. Alternately or additionally, the serial combiner devices 120 may enable and/or disable the DC power from each of the serial combiner devices 120 in response to a command from another device or system.

In some embodiments, the parallel combiner device 130 may be configured to enable the DC power of multiple of the serial combiner devices 120 in response to the voltages, currents, and/or power of the DC power being within a difference threshold of each other. In these and other embodiments, the parallel combiner device 130 may disable the DC power of one or more of the serial combiner devices 120 so that the voltages, currents, and/or power of the DC power of the serial combiner devices 120 that are enabled are within the difference threshold. In these and other embodiments, the parallel combiner device 130 may enable or disable the DC power of one or more of the serial combiner devices 120 based on commands from another device or system.

In some embodiments, when one or more of the differences between the voltages, currents, and/or power from the serial combiner devices 120 are not within the difference threshold, the parallel combiner device 130 may be configured to enable the DC power from the serial combiner devices 120 with the highest voltage, current, and/or power. Alternately or additionally, when one or more of the differences between the voltages, currents, and/or power from the serial combiner devices 120 are not within the difference threshold, the parallel combiner device 130 may be configured to enable the DC power from the combined serial combiner devices 120 with the highest number of serial combiner devices 120 in a combination. For example, if the environment 100 included five serial combiner devices 120 and the serial combiner devices 120 were combined into two combinations, one combination including three serial combiner devices 120 and the other combination including two serial combiner devices 120, the parallel combiner device 130 may enable the DC power from the combination of three serial combiner devices 120.

Alternately or additionally, when one or more of the differences between the voltages, currents, and/or power from the serial combiner devices 120 are not within the difference threshold, the parallel combiner device 130 may be configured to enable the DC power from the serial combiner devices 120 that results in the highest amount of power being output by the parallel combiner device 130.

For example, the parallel combiner device 130 may be configured to output the highest DC power through either a first combination of the DC power from the serial combiner devices 120, the DC power from a second combination of the serial combiner devices 120, or the DC power from a single one of the serial combiner devices 120.

For example, the parallel combiner device 130 may compare the voltage, current, and/or power of the first serial combiner device 120a with the voltage, current, and/or power of the second serial combiner device 120b. In response to a difference between the voltages, currents, and/or power based on the comparison being within the difference threshold, the voltage, current, and/or power of the third serial combiner device 120c may be compared to both the voltage, current, and/or power of the first serial combiner device 120a and the voltage, current, and/or power of the second serial combiner device 120b. In response to the voltage, current, and/or power of the third serial combiner device 120c being within the difference threshold of both of the voltages, currents, and/or power of the first serial combiner device 120a and the second serial combiner device 120b, the DC power of the third serial combiner device 120c may be enabled.

In some embodiments, in response to the voltage, current, and/or power of the third serial combiner device 120c not being within the difference threshold of one or both of the voltages, currents, and/or power of the first serial combiner device 120a and the second serial combiner device 120b, the combined DC power from the first serial combiner device 120a and the second serial combiner device 120b may be compared to the DC power from the third serial combiner device 120c. In response to the DC power from the third serial combiner device 120c being greater than the combined DC power from the first serial combiner device 120a and the second serial combiner device 120b, the parallel combiner device 130 may enable the DC power from the third serial combiner device 120c and disable the DC power from the first serial combiner device 120a and the second serial combiner device 120b. In response to the DC power from the third serial combiner device 120c being less than the combined DC power from the first serial combiner device 120a and the second serial combiner device 120b, the parallel combiner device 130 may disable the DC power from the third serial combiner device 120c and enable the combined DC power from the first serial combiner device 120a and the second serial combiner device 120b.

As another example, in response to a difference between the voltages, currents, and/or power of the DC power of the first serial combiner device 120a and the second serial combiner device 120b not being within the difference threshold, the parallel combiner device 130 may compare the voltage, current, and/or power of the third serial combiner device 120c to both the voltage, current, and/or power of the first serial combiner device 120a and the voltage, current, and/or power of the second serial combiner device 120b. In response to the voltage, current, and/or power of the third serial combiner device 120c being within the difference threshold of the first serial combiner device 120a and the combined DC power of the first serial combiner device 120a and the third serial combiner device 120c being greater than the DC power of the second serial combiner device 120b, the DC power of the first serial combiner device 120a and the third serial combiner device 120c may be enabled and the DC power of the second serial combiner device 120b may be disabled.

In response to the voltage, current, and/or power of the third serial combiner device 120c being within the difference threshold of the second serial combiner device 120b and the combined DC power of the second serial combiner device 120b and the third serial combiner device 120c being greater than the DC power of the first serial combiner device 120a, the DC power of the second serial combiner device 120b and the third serial combiner device 120c may be enabled and the DC power of the first serial combiner device 120a may be disabled.

In some embodiments, the parallel combiner device 130 may be configured to enable the DC power from the serial combiner devices 120 based on one or more rules or desired outcomes. For example, the parallel combiner device 130 may include a rule to select DC power from the serial combiner devices 120 that are within a particular threshold voltage. In these and other embodiments, the particular threshold voltage may be a mathematical combination of the voltages, current, and/or power generated by the serial combiner devices 120. For example, the particular threshold voltage may be mean, medium, weight mean, or some other combination of the voltages, current, and/or power generated by the serial combiner devices 120. Alternately or additionally, the particular threshold voltage may be selected based on one or more characteristics of the battery system 140, such as a type, charging capacity, input voltage, power levels, among other characteristics of the battery system 140. For example, when a power level of the battery system 140 is above a particular power level, such as 80% power capacity, the particular threshold voltage may be lower than when the power level of the battery system 140 is below a particular power level. Alternately or additionally, the particular threshold voltage may be selected based on one or more characteristics of the environment 100, such as a maximum voltage of the parallel combiner device 130 and other characteristics of the environment 100. Alternately or additionally, selection of a rule to apply by the parallel combiner device 130 may be based on the one or more characteristics of the battery system 140 or the one or more characteristics of the environment 100.

Alternately or additionally, a rule may include selecting the serial combiner devices 120 with the highest or lowest voltage, current, and/or power. Alternately or additionally, a rule may include selecting the serial combiner devices 120 based on the voltage, current, and/or power or differences between the voltage, current, and/or power of the serial combiner devices 120.

In some embodiments, the parallel combiner device 130 may be configured to enable and/or disable the DC power from each of the serial combiner devices 120 in real-time based on real-time information of the electrical characteristics of the DC power. For example, the parallel combiner device 130 may monitor the electrical characteristics of the DC power and based on real-time information of the electrical characteristics, the parallel combiner device 130 may adjust, in real-time, which of the serial combiner devices 120 is combined in parallel. For example, all the other solar panel groups 112 may be in the full sun for a first part of the day and provide similar electrical characteristics. However, during a second part of the day, one or more of the solar panel groups 112 may be shaded such that the electrical characteristic generated by one of the serial combiner devices 120 may be less than the electrical characteristic generated by the other serial combiner devices 120. In these and other embodiments, the parallel combiner device 130 may detect the difference and adjust which of the serial combiner devices 120 are combined to provide power to the battery system 140. The adjustment may occur in real-time in response to the detection of the difference. In these and other embodiments, in a third part of the day, the one or more of the solar panel groups 112 that was shaded may be exposed to the sun such that the parallel combiner device 130 adjusts again so that all the other solar panel groups 112 are again combined in parallel. Thus, the parallel combiner device 130 may be configured to adjust the DC power from the serial combiner devices 120 that are combined in real-time based on real-time changes in the environment 100 of the solar panel groups 112, changes to the solar panel groups 112, among other changes that may cause changes to the electrical characteristics of the DC power output by the solar panel groups 112 and thus the serial combiner devices 120.

In some embodiments, the parallel combiner device 130 may include one or more circuits, processors, or devices configured to detect voltages, currents, and/or power, compare voltages, currents, and/or power, calculate power, determine which of the serial combiner devices 120 to enable and disable, and to disable and enable the serial combiner devices 120. Alternately or additionally, the parallel combiner device 130 may collect information and provide the information to another device, such as the battery system 140, or another device and/or system. In these and other embodiments, the other device may determine which of the serial combiner devices 120 to enable and/or disable and provide the information to the parallel combiner device 130 for execution.

In some embodiments, the parallel combiner device 130 may be electrically coupled to the battery system 140. In these and other embodiments, the parallel combiner device 130 may be configured to provide DC power to the battery system 140 from those serial combiner devices 120 that are enabled.

In some embodiments, the battery system 140 may be configured to use the DC power to charge one or more batteries. In these and other embodiments, the battery system 140 may condition the DC power, such as by adjusting a voltage of the DC power, before charging the one or more batteries. The batteries may be any type or configuration of batteries.

In some embodiments, the power source 122 may be the electrical grid. In these and other embodiments, the parallel combiner device 130 may direct the DC power from the parallel combiner device 130 to either the battery system 140 or the power source 122. Alternately or additionally, the battery system 140 may use the power from the parallel combiner device 130 or may direct the DC power to the power source 122. In these and other embodiments, the DC power may be conditioned, such as converted to AC power before being provided to the power source.

In some embodiments, the power source 122 may be a vehicle, generator, or other power source. In these and other embodiments, the parallel combiner device 130 may accept as an input power from one or more of the power sources 122. In these and other embodiments, the parallel combiner device 130 may select between sending power to the battery system 140 from one or more power sources 122 or from the serial combiner devices 120. In these and other embodiments, the parallel combiner device 130 may select the power to send to the battery system 140 based on the priority or availability among the power source 122 and the serial combiner devices 120 or based on characteristics of the voltage, current, and/or power of power source 122 and of the serial combiner devices 120. For example, the power source 122 may have a priority. As a result, the parallel combiner device 130 may provide power from the power source 122 when the power from the power source 122 is available. When power from the power source 122 is not available, the parallel combiner device 130 may couple the serial combiner devices 120 to the battery system 140. As another example, in response to the voltage, current, and/or power of the power source 122 being within a threshold or based on the characteristics of the power source, the power source 122 may be coupled to the battery system 140 and the serial combiner devices 120 may not be coupled to the battery system 140. Alternately or additionally, the parallel combiner device 130 may combine the power from the serial combiner devices 120 and the power sources 122 and provide the combined power to the battery system 140. In these and other embodiments, the parallel combiner device 130 may combine the serial combiner devices 120 and the power sources 122 based on the voltage, current, and/or power of power source and/or of the serial combiner devices 120 or based on commands from another device and/or system.

Modifications, additions, or omissions may be made to FIG. 1 without departing from the scope of the present disclosure. For example, in some embodiments, the environment 100 may include more or fewer serial combiner devices 120. In these and other embodiments, the parallel combiner device 130 may follow the procedures discussed in this disclosure to select which of the serial combiner devices 120 to enable and/or disable.

Alternately or additionally, the environment 100 may include multiple parallel combiner device 130 that are each connected to multiple serial combiner devices 120. Each of the multiple parallel combiner device 130 may provide power to the battery system 140.

FIG. 2 illustrates an example parallel combiner device 200, in accordance with some embodiments of the present disclosure. The parallel combiner device 200 may be an example of the parallel combiner device 130 of FIG. 1. The parallel combiner device 200 may include a first voltage detector 210a, a second voltage detector 210b, and a third voltage detector 210c, referred to as the voltage detectors 210, a first switch 220a, a second switch 220b, and a third switch 220c, referred to collectively as the switches 220, a control circuit 230, and a power combiner 240.

The first voltage detector 210a may be configured to obtain a first DC power from a first device, such as a serial combiner device, a solar panel, or another power source, such as a vehicle, generator, or electrical grid. The first voltage detector 210a may detect a first voltage, current, and/or power of the first DC power and provide the first voltage, current, and/or power to the control circuit 230. The first switch 220a may be coupled between the first voltage detector 210a and the power combiner 240. When the first DC power is enabled, the first switch 220a may be placed in a first position to electrically couple the first DC power to the power combiner 240. When the first DC power is disabled, the first switch 220a may be placed in a second position to electrically isolate the first DC power from the power combiner 240. Alternately or additionally, the first switch 220a may be placed in a third position to electrically couple the first DC power to another device or system, such as a battery system or other device without passing through the power combiner 240.

The second voltage detector 210b may be configured to obtain a second DC power from a second device, such as a serial combiner device, a solar panel, or another device. The second voltage detector 210b may detect a second voltage, current, and/or power of the second DC power and provide the second voltage, current, and/or power to the control circuit 230. The second switch 220b may be coupled between the second voltage detector 210b and the power combiner 240. When the second DC power is enabled, the second switch 220b may be placed in a first position to electrically couple the second DC power to the power combiner 240. When the second DC power is disabled, the second switch 220b may be placed in a second position to electrically isolate the second DC power from the power combiner 240. Alternately or additionally, the second switch 220b may be placed in a third position to electrically couple the second DC power to another device or system, such as a battery system or other device without passing through the power combiner 240.

The third voltage detector 210c may be configured to obtain a third DC power from a third device, such as a serial combiner device, a solar panel, or another device. The third voltage detector 210c may detect a third voltage, current, and/or power of the third DC power and provide the third voltage, current, and/or power to the control circuit 230. The third switch 220c may be coupled between the third voltage detector 210c and the power combiner 240. When the third DC power is enabled, the third switch 220c may be placed in a first position to electrically couple the third DC power to the power combiner 240. When the third DC power is disabled, the third switch 220c may be placed in a second position to electrically isolate the third DC power from the power combiner 240. Alternately or additionally, the third switch 220c may be placed in a third position to electrically couple the third DC power to another device or system, such as a battery system or other device without passing through the power combiner 240.

The control circuit 230 may be configured to obtain the first voltage, the second voltage, and the third voltage. The control circuit 230 may be compare the first voltage, the second voltage, and the third voltage and based on the comparison determine which of the first switch 220a, the second switch 220b, and the third switch 220c is to be in the first position, the second position, or the third position to determine which of the first DC power, the second DC power, and the third DC power is provided to the power combiner 240 or output by the parallel combiner device 200.

In some embodiments, the control circuit 230 may be any circuit configured to obtain the first voltage, current, and/or power, the second voltage, current, and/or power, and the third voltage, current, and/or power, compare the voltages, currents, and/or powers, and control the switches 220 based on the comparison of the voltages, currents, and/or powers to enable or disable the first DC power, the second DC power, and the third DC power. For example, the control circuit 230 may include analog and/or digital circuitry configured to perform the functions described herein. In these and other embodiments, the control circuit 230 may include an application-specific integrated circuit (ASIC), a Field-Programmable Gate Array (FPGA), microprocessor, processor, or any other digital or analog circuitry configured to interpret and/or to execute program instructions and/or to process data. For example, the control circuit 230 may include one or more elements described in the system 500. Alternately or additionally, the control circuit 230 may include a communication unit, such as described in the system 500, and may provide the first voltage, current, and/or power, the second voltage, current, and/or power, and the third voltage, current, and/or power to another device, such as a storage device. In these and other embodiments, the control circuit 230 may obtain information from the other device regarding how to control the switches 220. Alternately or additionally, the control circuit 230 may be configured to control the switches 220 based on a command from another device and/or system. In these and other embodiments, the control circuit 230 may not rely on the electrical characteristics of the DC power and may control the switches 220 based on the command. Alternately or additionally, the control circuit 230 may adjust how the switches 220 are controlled based on the electrical characteristics of the DC power based on a command or data from another device and/or system. For example, the control circuit 230 may obtain data regarding one or more characteristics of a battery system coupled to the parallel combiner device 200. In these and other embodiments, the control circuit 230 may be configured to adjust how the switches 220 are controlled based on the data. For example, when the battery system has a level below a threshold, the control circuit 230 may control the switches 220 so that the most amount of power is provided to the battery system. In contrast, in response to the battery system being above a threshold, the control circuit 230 may control the switches 220 so that a particular voltage or a lowest power or current is provided to the battery system.

The power combiner 240 may be configured to obtain the DC power inputs from the switches 220. In response to the power combiner 240 obtaining a single DC power input, the power combiner 240 may output the DC power input. In response to the power combiner 240 obtaining multiple DC power inputs, the power combiner 240 may parallelly combine the multiple DC power inputs and output the combined DC power. In these and other embodiments, the power combiner 240 may include one or more analog or digital circuits configured to parallelly combine DC power inputs.

Modifications, additions, or omissions may be made to FIG. 2 without departing from the scope of the present disclosure. For example, in some embodiments, the parallel combiner device 200 may include more or fewer than three inputs. For example, the parallel combiner device 200 may include 2, 4, 5, 6, 7, 8, or more inputs. In these and other embodiments, the number of voltage detectors 210 and switches 220 may be adjusted based on the number of inputs.

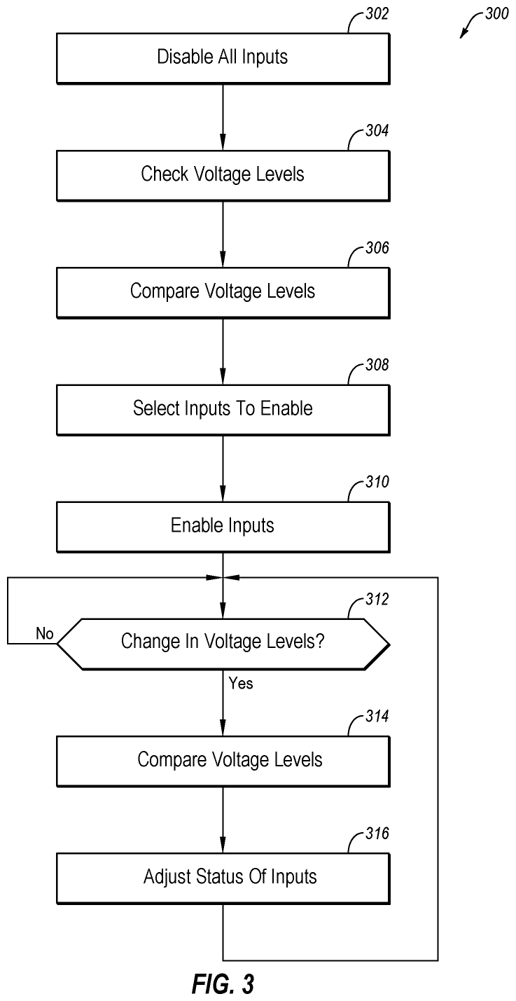

FIG. 3 illustrates a flowchart of an example method 300 to perform power combining. The method 300 may be arranged in accordance with at least one embodiment described in the present disclosure. One or more operations of the method 300 may be performed, in some embodiments, by a device or system, such as the parallel combiner device 130 or the parallel combiner device 200 of FIGS. 1 and 2 or another device or combination of devices or control systems. In these and other embodiments, the method 300 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 300 may begin at block 302, where all DC power inputs in a parallel combiner device may be disabled. The DC power inputs may be disabled at an initialization of the parallel combiner device, after a power down, or after no power being provided to the parallel combiner device.

At block 304, the parallel combiner device may detect a voltage, current, and/or power level of each of the DC power inputs. The voltage, current, and/or power level of each of the DC power inputs may be provided from multiple solar panels, through a serial power combiner, or from a power source, such as an electrical grid, vehicle, or generator.

At block 306, the parallel combiner device may compare the voltage, current, and/or power levels of each of the DC power inputs. In these and other embodiments, the parallel combiner device may compare a difference between the voltage, current, and/or power levels to a threshold level. The threshold level may be based on a configuration and/or tolerances of the devices that generate the DC power inputs and/or other devices in a system that include the parallel combiner device.

At block 308, the parallel combiner device may select inputs of the parallel combiner device to enable based on the comparison of the voltage levels. The parallel combiner device may select the DC power inputs to enable that include voltages, current, and/or power within the threshold level of each other. In response to all the DC power inputs not having voltages within the threshold level of each other, the parallel combiner device may select the DC power input to enable with the highest voltage and/or power. Alternately or additionally, in response to all the DC power inputs not having voltages within the threshold level of each other, the parallel combiner device may select a subset of the DC power inputs to enable with voltages, currents, and/or power within the threshold level of each other.

At block 310, the parallel combiner device may enable the DC power inputs selected at block 308. Enabling the DC power inputs may result in the parallel combiner device parallelly combining the DC power inputs when multiple DC power inputs are enabled and providing the combined DC power as an output. In response to a single DC power input being enabled, the parallel combiner device may provide the single DC power input as an output.

At block 312, it may be determined if there is a change in the voltage, current, and/or power level of one of the DC power inputs. In response to a change in a voltage, current, and/or power level of a DC power input, the method 300 may proceed to block 314. In response to no change in a voltage, current, and/or power level of a DC power input, the method 300 may proceed to block 312 and continue monitoring the voltages, currents, and/or power levels of the DC power inputs.

In some embodiments, the change in the voltage, current, and/or power level of one of the DC power inputs may be determined in real-time. In these and other embodiments, the change may be determined at particular intervals such as every second, minute, hour, or day, among other intervals; randomly; based on commands or user input; a change in an environment that includes power source for parallel combiner device, such as a change in sun light on solar panels coupled to the parallel combiner device, a change in weather, or other environmental change; a change in a battery system coupled to the parallel combiner device, such as a type of battery in the battery system, the battery system itself, a power level of the battery system, a demand on the battery system; among other changes.

At block 314, the parallel combiner device may compare the voltage, current, and/or power levels of each of the DC power inputs. The comparison may be similar to the comparison performed at block 306.

At block 316, the parallel combiner device may adjust the status of the DC power inputs based on the comparison performed at block 314. For example, the parallel combiner device may enable a disabled DC power input, disable an enabled DC power input, and/or maintain a status of a DC power input based on the comparison performed at block 314.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments. For example, in some embodiments, the method 300, the parallel combiner device may adjust the status of the DC power inputs based on commands from another device or system. In these and other embodiments, the method 300 may not include the parallel combiner device obtain and/or comparing the voltage, current, and/or power levels of each of the DC power inputs.

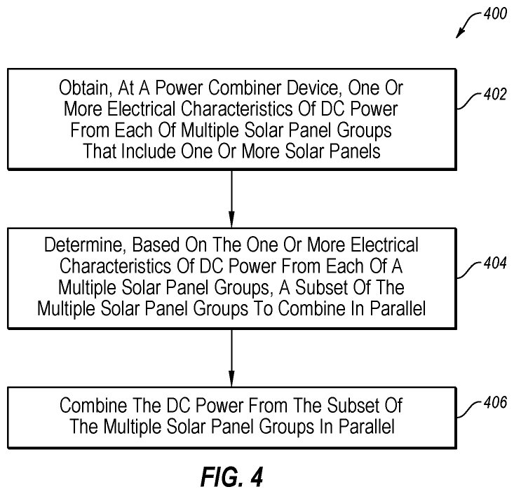

FIG. 4 illustrates a flowchart of an example method 400 to perform power combining. The method 400 may be arranged in accordance with at least one embodiment described in the present disclosure. One or more operations of the method 400 may be performed, in some embodiments, by a device or system, such as the parallel combiner device 130 or the parallel combiner device 200 of FIGS. 1 and 2 or another device or combination of devices or control systems. In these and other embodiments, the method 400 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 400 may begin at block 402, where one or more electrical characteristics of DC power may be obtained at a power combiner device from each of multiple solar panel groups that include one or more solar panels. In some embodiments, the DC power from one of the multiple solar panel groups may be generated by serially combining DC power from a first set of solar panels of the multiple solar panel groups. In these and other embodiments, the DC power from another of the multiple solar panel groups may be generated by serially combining DC power from a second set of solar panels of the multiple solar panel groups. In these and other embodiments, a number of solar panels in the first set of solar panels and in the second set of solar panels may be configured to generate an approximately same amount of current, voltage, or power.

At block 404, determine, based on the one or more electrical characteristics of DC power from each of multiple solar panel groups, a subset of the multiple solar panel groups to combine in parallel. At block 406, combine the DC power from the subset of the multiple solar panel groups in parallel.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments. For example, in some embodiments, the method 400 may include providing the combined DC power to a battery system for charging of a battery of the battery system. In these and other embodiments, the subset of the multiple solar panel groups to combine in parallel may be determined based on one or more characteristics of the battery system.

Alternately or additionally, the method 400 may further include after combining the DC power, adjusting which of the multiple solar panel groups to combine in parallel in real-time based on changing electrical characteristics of DC power from one or more of the multiple solar panel groups.

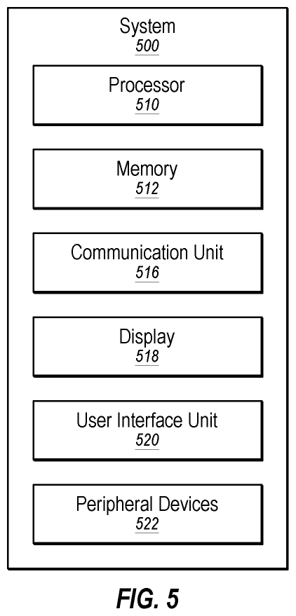

FIG. 5 illustrates an example system 500 that may be used with one or more embodiments provided in this disclosure. The system 500 may be arranged in accordance with at least one embodiment described in the present disclosure. The system 500 may include a processor 510, memory 512, a communication unit 516, a display 518, a user interface unit 520, and a peripheral device 522, which all may be communicatively coupled. In some embodiments, the system 500 may be part of any of the systems or devices described in this disclosure. For example, the system 500 or part of the system may be part of the parallel combiner device 130 or battery system 140 of FIG. 1 and may be configured to perform one or more of the tasks described above with respect to the parallel combiner device 130 and/or the battery system 140. Alternately or additionally, the system or parts of the system 500 may be part of the control circuit 230 of FIG. 2 and may be configured to perform the operations performed by the control circuit 230.

Generally, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, it is understood that the processor 510 may include any number of processors distributed across any number of networks or physical locations that are configured to perform individually or collectively any number of operations described herein. In some embodiments, the processor 510 may interpret and/or execute program instructions and/or process data stored in the memory 512. In some embodiments, the processor 510 may execute the program instructions stored in the memory 512.

For example, in some embodiments, the processor 510 may execute program instructions stored in the memory 512 that are related to transcription presentation such that the system 500 may perform or direct the performance of the operations associated therewith as directed by the instructions. In these and other embodiments, the instructions may be used to perform one or more operations of the method 300 or 400 of FIGS. 3 and 4.

The memory 512 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 510.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 510 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 516 may include any component, device, system, or combination thereof that is configured to transmit or receive information over a network. In some embodiments, the communication unit 516 may communicate with other devices at other locations, the same location, or even other components within the same system. For example, the communication unit 516 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 516 may permit data to be exchanged with a network and/or any other devices or systems described in the present disclosure.

The display 518 may be configured as one or more displays, like an LCD, LED, Braille terminal, or other type of display. The display 518 may be configured to present data as directed by the processor 510.

The user interface unit 520 may include any device to allow a user to interface with the system 500. For example, the user interface unit 520 may include a mouse, a track pad, a keyboard, buttons, camera, and/or a touchscreen, among other devices. The user interface unit 520 may receive input from a user and provide the input to the processor 510. In some embodiments, the user interface unit 520 and the display 518 may be combined.

The peripheral devices 522 may include one or more devices. For example, the peripheral devices may include a microphone, an imager, and/or a speaker, among other peripheral devices. In these and other embodiments, the microphone may be configured to capture audio. The imager may be configured to capture images. In some embodiments, the speaker may broadcast audio received by the system 500 or otherwise generated by the system 500.

Modifications, additions, or omissions may be made to the system 500 without departing from the scope of the present disclosure. For example, in some embodiments, the system 500 may include any number of other components that may not be explicitly illustrated or described. Further, depending on certain implementations, the system 500 may not include one or more of the components illustrated and described.

As indicated above, the embodiments described herein may include the use of a special purpose or general-purpose computer (e.g., the processor 510 of FIG. 5) including various computer hardware or software modules, as discussed in greater detail below. Further, as indicated above, embodiments described herein may be implemented using computer-readable media (e.g., the memory 512 of FIG. 5) for carrying or having computer-executable instructions or data structures stored thereon.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A charging system comprising:
a plurality of solar panels, each of the solar panels configured to generate DC power, the plurality of solar panels divided into a plurality of solar panel groups; and
a power combiner device electrically coupled to the plurality of solar panel groups and configured to selectively combine the DC power from the plurality of solar panel groups connected thereto in parallel based on electrical characteristics of the DC power from the plurality of solar panel groups.

2. The system of claim 1, wherein the selectively combining the DC power from the plurality of solar panel groups includes in some operations combining the DC power from two or more of the plurality of solar panel groups while disregarding the DC power from the other of the plurality of solar panel groups.

3. The system of claim 1, wherein the power combiner device includes a control circuit configured to:
obtain the electrical characteristics of the DC power from the plurality of solar panel groups;
determine the DC power from the plurality of solar panel groups to combine in parallel based on the electrical characteristics; and
direct combination of the DC power from the plurality of solar panel groups determined to be combined.

4. The system of claim 1, wherein the power combiner device is further configured to:
monitor the electrical characteristics of the DC power; and
adjust which of the DC power from the plurality of solar panel groups connected thereto is combined in parallel based on changes to the electrical characteristics of the DC power.

5. The system of claim 1, wherein the power combiner device is configured to adjust which of the DC power from the plurality of solar panel groups connected thereto is combined in parallel in real-time based on changes to the electrical characteristics of the DC power.

6. The system of claim 1, further comprising a plurality of second power combiner devices, each of the plurality of second power combiner devices coupled to the power combiner device and coupled to two or more of the solar panel group and configured to serially combine the DC power from the two or more of the solar panels connected thereto and provide the serially combined DC power to the power combiner device.

7. The system of claim 6, wherein the plurality of solar panel groups are configured to have a number of the plurality of solar panels such that each of the plurality of solar panel groups is configured to provide an approximately same amount of current, voltage, or power to the plurality of second power combiner devices.

8. The system of claim 1, further comprising a battery system coupled to the power combiner device, the battery system configured to be charged by the combined DC power provided by the power combiner device.

9. The system of claim 1, further comprising a power source electrically coupled to the power combiner device, the power source configured to provide power to the power combiner device, the power combiner device configured to output the power from the power combiner device in place of the DC power from the plurality of solar panels or combine the power with the DC power from the plurality of solar panels.

10. A charging system comprising:
a plurality of solar panels, each of the solar panels configured to generate DC power;
a plurality of first power combiner devices, each of the plurality of first power combiner devices coupled to a different group of solar panels and configured to serially combine the DC power from the solar panels of the solar panel group connected thereto, where each of the plurality of solar panels is in one of the different groups of solar panels; and
a second power combiner device coupled to each of the plurality of first power combiner devices, the second power combiner configured to selectively combine the DC power from the plurality of first power combiner devices in parallel based on electrical characteristics of the DC power from the plurality of first power combiner devices.

11. The system of claim 10, wherein the selectively combining the DC power from the plurality of solar panel groups includes in some operations combining the DC power from two or more of the plurality of solar panel groups while disregarding the DC power from the other of the plurality of solar panel groups.

12. The system of claim 10, wherein the power combiner device is configured to adjust which of the DC power from the plurality of solar panel groups connected thereto is combined in parallel in real-time based on changes to the electrical characteristics of the DC power.

13. The system of claim 10, further comprising a battery system coupled to the power combiner device, the battery system configured to be charged by the combined DC power provided by the power combiner device.

14. The system of claim 13, wherein the power combiner device is configured to selectively combine the DC power further based on one or more characteristics of the battery system.

15. A method to combine power, the method comprising:
obtaining, at a power combiner device, one or more electrical characteristics of DC power from each of a plurality of solar panel groups that include one or more solar panels;
determining, based on the one or more electrical characteristics of DC power from each of a plurality of solar panel groups, a subset of the plurality of solar panel groups to combine in parallel; and
combining the DC power from the subset of the plurality of solar panel groups in parallel.

16. The method of claim 15, wherein the DC power from one of the plurality of solar panel groups is generated by serially combining DC power from a first set of solar panels of the plurality of solar panel groups.

17. The method of claim 16, wherein the DC power from another of the plurality of solar panel groups is generated by serially combining DC power from a second set of solar panels of the plurality of solar panel groups, wherein a number of solar panels in the first set of solar panels and in the second set of solar panels is configured to generate an approximately same amount of current, voltage, or power.

18. The method of claim 15, further comprising providing the combined DC power to a battery system for charging of a battery of the battery system.

19. The method of claim 18, wherein the subset of the plurality of solar panel groups to combine in parallel is determined based on one or more characteristics of the battery system.

20. The method of claim 15, further comprising after combining the DC power, adjusting which of the plurality of solar panel groups to combine in parallel in real-time based on changing electrical characteristics of DC power from one or more of the plurality of solar panel groups.
